(19) United States
(12) Patent Application Publication
(10) Pub. No.: US 2024/0344551 A1
(43) Pub. Date: Oct. 17, 2024

(54) Fastening Assembly and Fastening System Comprising Same

(71) Applicant: Illinois Tool Works Inc., Glenview, IL (US)

(72) Inventors: Gang YU, Shanghai (CN); Bin CHEN, Shanghai (CN)

(21) Appl. No.: 18/635,258

(22) Filed: Apr. 15, 2024

(30) Foreign Application Priority Data
Apr. 17, 2023 (CN) 202310411013.7
Sep. 13, 2023 (CN) 202311177917.4
Mar. 1, 2024 (CN) 202410239540.9

(51) Int. Cl. F16B 43/00

(52) U.S. Cl. CPC F16B 43/00

(57) ABSTRACT

Disclosed is a fastening assembly, comprising a fastening element, a compensation element, a holding element, and a limiting element. A limiting portion of the fastening element is provided at a head or between the head and a threaded portion and protrudes outward relative to an outer peripheral surface of the head. The compensation element includes a main body and a receiving hole running therethrough. The main body is provided with a limiting flange to stop the fastening element, and the compensation element can be connected to a first component and move relative to the first component in a longitudinal direction. The holding element at least partially surrounds the head. At least a part of the holding element has elasticity, and the holding element is configured to hold the fastening element substantially centrally in the receiving hole when the fastening element is not fastened to a second component, and to allow the fastening element to move relative to the compensation element in a transverse direction when the fastening element is fastened to the second component.

### RELATED APPLICATIONS

The present application claims the benefit of Chinese Patent Application No. 202310411013.7, filed Apr. 17, 2023; Chinese Patent Application No. 202311177917.4, filed Sep. 13, 2023, and Chinese Patent Application No. 202410239540.9, filed Mar. 1, 2024, each titled “Fastening Assembly and Fastening System Comprising Same,” the contents of which are hereby incorporated by reference.

### TECHNICAL FIELD

Embodiments of the present disclosure generally relate to a fastening assembly, and more particularly, to a fastening assembly configured to fasten a first component to a second component and be capable of compensating for tolerances.

### BACKGROUND

A fastening assembly with a tolerance compensating function can compensate for tolerances caused by manufacturing and mounting while fastening two components. The fastening assembly typically comprises a threaded fastening element, via which the two components are fastened.

### SUMMARY OF THE DISCLOSURE

The present disclosure relates generally to a fastening assembly for fastening a first component to a second component, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a fastening system according to an embodiment of the present disclosure from a first perspective.

FIG. 1B is a perspective view of the fastening system shown in FIG. 1A from a second perspective.

FIG. 1C is a perspective view of the fastening system shown in FIG. 1A from a third perspective.

FIG. 1D is a cross-sectional view of the fastening system shown in FIG. 1A taken in an axial direction.

FIG. 1E is an exploded view of the fastening system shown in FIG. 1A.

FIG. 1F is a schematic diagram showing an assembly process of the fastening system shown in FIG. 1A.

FIG. 2A is a perspective view of a compensation element of the fastening system shown in FIG. 1A.

FIG. 2B is a cross-sectional view of the compensation element shown in FIG. 2A taken in an axial direction.

FIG. 2C is a partial enlarged view of part K in FIG. 2B.

FIG. 3A is a perspective view of a fastening assembly according to another embodiment of the present disclosure from a first perspective.

FIG. 3B is a perspective view of the fastening assembly shown in FIG. 3A from a second perspective.

FIG. 3C is a left view of the fastening assembly shown in FIG. 3A.

FIG. 3D is a cross-sectional view of the fastening assembly shown in FIG. 3A taken in an axial direction.

FIG. 3E is an exploded view of the fastening assembly shown in FIG. 3A.

FIG. 4A is a perspective view of a fastening assembly according to a further embodiment of the present disclosure.

FIG. 4B is a cross-sectional view of the fastening assembly shown in FIG. 4A taken in an axial direction.

FIG. 4C is an exploded view of the fastening assembly shown in FIG. 4A.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. It is to be understood that although the terms indicating orientations, such as “front”, “rear”, “upper”, “lower”, “left”, “right”, “top” and “bottom”, are used in the present disclosure to describe structural parts and elements in various examples of the present disclosure, these terms are used herein only for ease of illustration and are determined based on the exemplary orientations shown in the accompanying drawings. Since the embodiments disclosed in the present disclosure can be arranged in different directions, these terms indicating directions are only illustrative and should not be considered as limitations. Furthermore, it should be understood that some features, structures, or characteristics in one or more embodiments of the present disclosure may be combined appropriately.

In a first aspect of the present disclosure, the present disclosure provides a fastening assembly for fastening a first component to a second component. The fastening assembly comprises a fastening element, a compensation element, a holding element, and a limiting element. The fastening element comprises a head, a threaded portion, and a limiting portion. The limiting portion is provided at the head or between the head and the threaded portion, and the limiting portion protrudes outward relative to an outer peripheral surface of the head. The compensation element comprises a main body and a receiving hole. The receiving hole runs through the main body in an axial direction of the compensation element to receive the fastening element, and the main body is provided with a limiting flange at an end thereof to stop the fastening element. The compensation element is configured to be connectable to the first component and movable relative to the first component in a longitudinal direction. The holding element is arranged at least partially around the head of the fastening element. At least a part of the holding element has elasticity. The holding element is configured to hold the fastening element substantially centrally in the receiving hole when the fastening assembly is not fastened to the second component, and to allow the fastening element to move relative to the compensation element in a transverse direction perpendicular to the longitudinal direction when the fastening assembly is fastened to the second component. The limiting element is connected to the compensation element and provided in the receiving hole, and the limiting element is configured to limit the holding element in the receiving hole in the longitudinal direction. The limiting portion of the fastening element is limited between the holding element and the limiting flange of the compensation element in the longitudinal direction, so as to be held in the receiving hole.

In the fastening assembly according to the first aspect described above, the main body of the compensation element comprises a first compensation section and a second compensation section which are arranged in the axial direction of the compensation element and are detachably connected to each other, wherein the limiting flange is provided on the first compensation section, and the second compensation section provides the limiting element.

In the fastening assembly according to the first aspect described above, the limiting element is a cylinder extending out from the second compensation section and extending into the first compensation section.

In the fastening assembly according to the first aspect described above, the first compensation section and the second compensation section are respectively made of different materials, wherein the second compensation section has a strength less than that of the first compensation section.

In the fastening assembly according to the first aspect described above, the holding element comprises an outer peripheral portion and a plurality of elastic arms arranged at intervals around an axis of the holding element, wherein the elastic arms each comprise an arm inner end close to the head of the fastening element and an arm outer end away from the head, and the arm outer end is connected to the outer peripheral portion.

In the fastening assembly according to the first aspect described above, each of the elastic arms extends in a bent manner from the arm outer end to the arm inner end.

In the fastening assembly according to the first aspect described above, each of the elastic arms comprises an inner side surface opposite the outer peripheral surface of the head, and as viewed from a cross-sectional perspective, at least at the arm inner end and near the arm inner end, an included angle between the inner side surface and the outer peripheral surface is less than 90°.

In the fastening assembly according to the first aspect described above, the outer peripheral surface of the head comprises a cylindrical surface opposite the inner side surfaces of the elastic arms.

In the fastening assembly according to the first aspect described above, when the fastening element is exactly centrally located in the receiving hole, there is a radial gap between the arm inner end of each of the elastic arms and the head of the fastening element.

In the fastening assembly according to the first aspect described above, each of the elastic arms comprises a proximal end surface opposite the limiting portion of the fastening element, and the limiting portion comprises a limiting portion end surface opposite the proximal end surface, wherein the proximal end surfaces of the plurality of elastic arms are coplanar and are parallel to the limiting portion end surface.

In the fastening assembly according to the first aspect described above, the limiting element is a component integrally formed with the holding element or a component separated from the holding element.

In the fastening assembly according to the first aspect described above, the holding element is made of an elastic material, and the holding element has an annular cross-section.

In the fastening assembly according to the first aspect described above, the main body of the compensation element is provided with a helical groove on an outer surface thereof, and the spiral groove is configured to connect the compensation element to the first component, wherein the compensation element comprises a first stop structure and a second stop structure respectively arranged at two ends thereof in the axial direction, and the first stop structure and the second stop structure are configured to allow the compensation element to be inserted into a hole of the first component, and to block the compensation element from falling off from the hole of the first component, so as to pre-assemble the fastening assembly on the first component, wherein one of the first stop structure and the second stop structure comprises a stop block provided at an end of the helical groove, and the other of the first stop structure and the second stop structure comprises a biasable stop arm extending substantially in a circumferential direction of the main body.

According to a second aspect of the present disclosure, the present disclosure provides a fastening system, comprising a fastening assembly according to the first aspect described above and a first component.

The embodiments of the present disclosure provide a fastening assembly, which is configured to cooperate with a fastening element (e.g., a bolt) to fasten a first component (e.g., a door handle module of a vehicle) to a second component (e.g., a door of the vehicle), and the fastening assembly also has a tolerance compensating function and thus can compensate for tolerances caused by the manufacturing and assembly of components. The embodiments of the present disclosure further provide a fastening system comprising a fastening assembly described above.

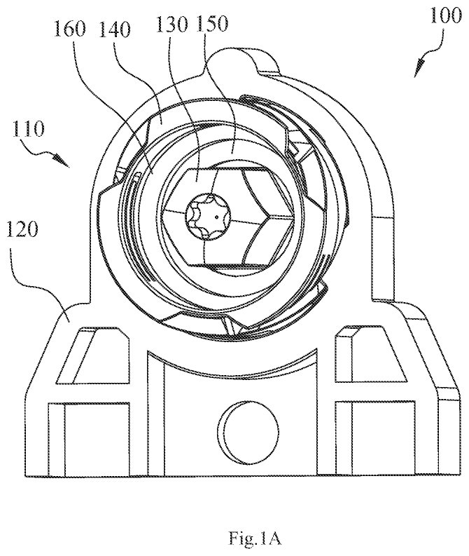

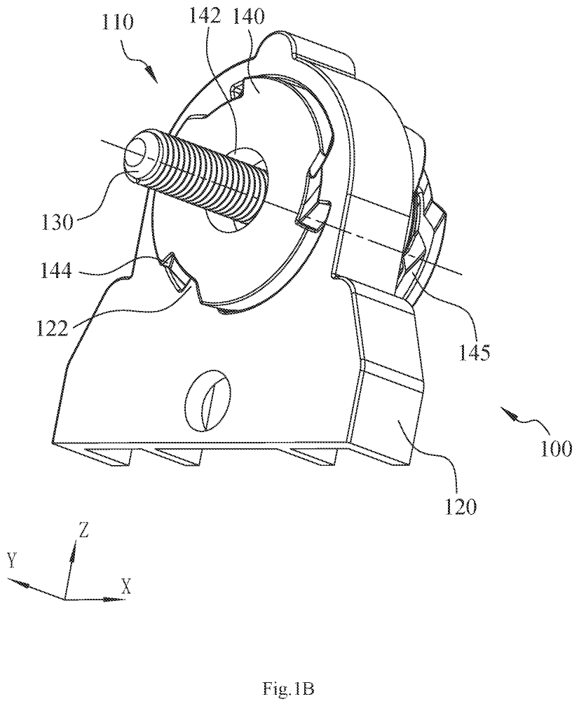

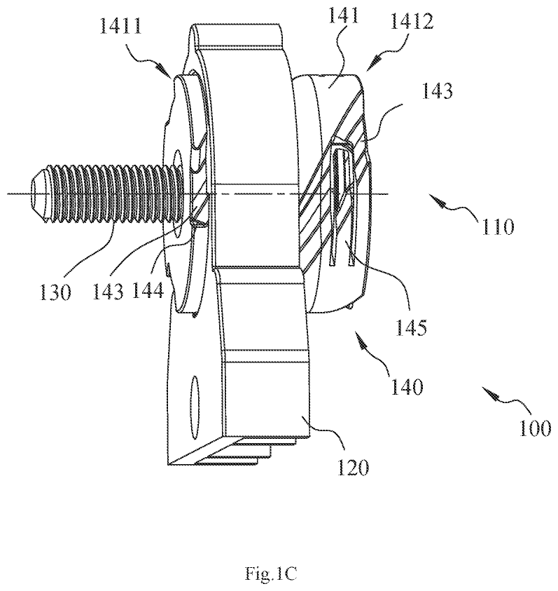

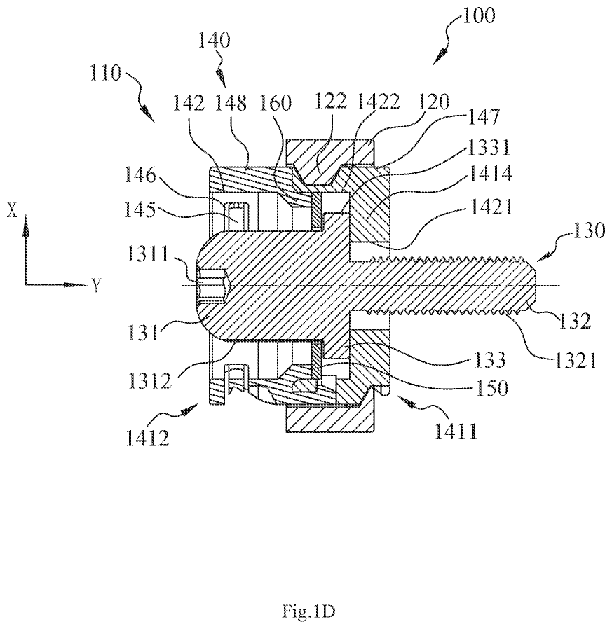

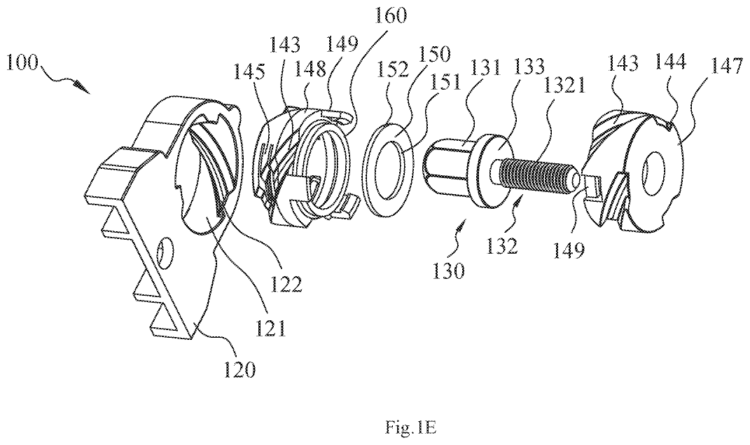

FIGS. 1A-1F illustrate an overall structure of a fastening system 100 according to an embodiment of the present disclosure. FIGS. 1A-1C are perspective views of the fastening system 100 from different perspectives, FIG. 1D is a cross-sectional view of the fastening system 100 taken in an axial direction, FIG. 1E is an exploded view of the fastening system 100, and FIG. 1F is a schematic diagram showing an assembly process of the fastening system 100.

As shown in FIGS. 1A-1F, the fastening system 100 comprises a fastening assembly 110 and a first component 120 (shown more clearly in FIGS. 1E and 1F), and the fastening assembly 110 is configured to fasten the first component 120 to a second component (not shown) and compensate for tolerances in various directions caused by manufacturing and/or assembly. The first component 120 is, for example, a door handle module of a vehicle, and the second component is, for example, a door of the vehicle. In order to show the fastening system 100 according to the present disclosure more clearly, a simplified structure of the first component 120 is shown.

Before being fastened to the second component, the fastening assembly 110 and the first component 120 may be pre-assembled together to form a pre-assembled unit, thereby facilitating a manufacturer of the first component 120 to directly provide, to an end user, an assembled unit that can be used for final assembly. For example, where the first component 120 is a door handle module of a vehicle, a manufacturer of the door handle module can purchase the fastening assembly from a manufacturer of the fastening assembly, assemble the fastening assembly on the door handle module it manufactures, and then sell the assembled unit to a vehicle manufacturer. In this way, the vehicle manufacturer can obtain an assembled unit for final assembly from a single supplier, which facilitates production management and optimal allocation of various resources. As will be described in detail below, the fastening assembly 110 pre-assembled on the first component 120 is not prone to falling off from the first component 120, which thus facilitates the transportation and storage of the pre-assembled unit formed by the first component 120 and the fastening assembly 110 and the mounting of the pre-assembled unit at a final assembly position.

With continued reference to FIGS. 1A-1F, the fastening assembly 110 comprises a fastening element 130, a compensation element 140, a holding element 150, and a limiting element 160 (shown more clearly in FIG. 1E).

As shown in FIGS. 1D and 1E, the fastening element 130 is a threaded fastening element, such as a bolt. The fastening element 130 comprises a head 131, a stem 132, and a limiting portion 133. The head 131 and the stem 132 are respectively provided at two ends of the fastening element 130. The stem 132 is provided with a threaded portion 1321, and the threaded portion 1321 is configured to engage with a thread on the second component, so as to fasten the first component 120 to the second component. The head 131 has a driving feature 1311, and the driving feature 1311 is configured to connect to a driving tool (not shown) to facilitate driving of the fastening element 130. The limiting portion 133 is configured to cooperate with the holding element 150 and the limiting element 160 to limit the fastening element 130, see below for details. At least a part of an outer side 1331 of the limiting portion 133 is further away from an axis of the fastening element 130 than an outer peripheral surface 1312 of the head 131. For example, the limiting portion 133 is a flange, which protrudes outward from the outer peripheral surface 1312 of the head 131 to form a substantially annular structure. Although in the illustrated embodiment, the limiting portion 133 is provided at the head 131, in some other embodiments, the limiting portion 133 may be provided at the stem 132 and between the head 131 and the threaded portion 1321.

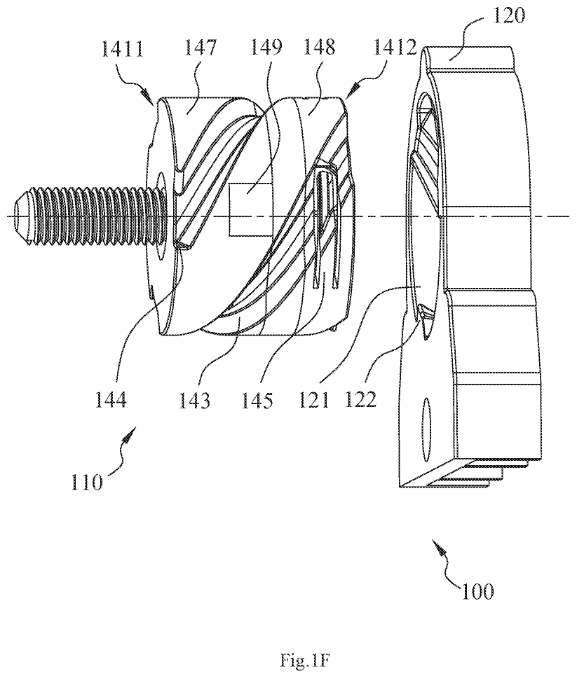

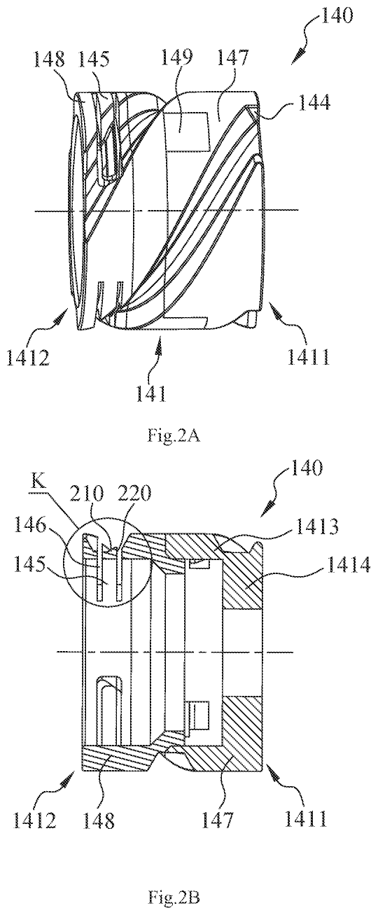

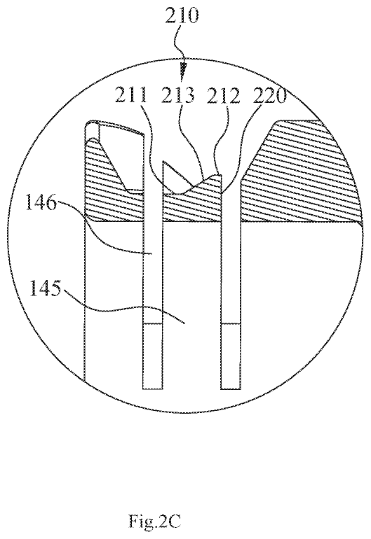

FIGS. 2A-2C illustrate a specific structure of the compensation element 140 of the fastening system 100 of FIG. 1A. FIG. 2A is a perspective view of the compensation element 140, FIG. 2B is a cross-sectional view of the compensation element 140 taken in an axial direction, and FIG. 2C is a partial enlarged view of part K in FIG. 2B.

As shown in FIGS. 1D, 1F, 2A and 2B, the compensation element 140 comprises a main body 141 and a receiving hole 142. The main body 141 is generally cylindrical, and comprises a first end 1411 and a second end 1412 respectively provided at two axial ends thereof. The receiving hole 142 extends from the first end 1411 to the second end 1412 so as to run through the main body 141.

As shown in FIGS. 1D, 1E and 2B, the main body 141 of the compensation element 140 is of a split structure, and comprises a first compensation section 147 and a second compensation section 148 that are arranged in the axial direction and are connected to each other. The first compensation section 147 and the second compensation section 148 respectively define the first end 1411 and the second end 1412, and are detachably connected to each other by means of a snap-fit structure 149 or by other means.

In some embodiments, the first compensation section 147 and the second compensation section 148 are respectively made of different materials. The second compensation section 148 has a strength less than that of the first compensation section 147. Since when the first component 120 is fastened to the second component, the first compensation section 147 needs to withstand an axial fastening force of the fastening element 130 and a pressure of the second component, that is, the first compensation section 147 is subjected to a larger stress, while the second compensation section 148 is subjected to a smaller stress. Therefore, the second compensation section 148 may be made of a material with a lower strength to reduce costs.

The compensation element 140 is configured to be connectable to the first component 120 and movable relative to the first component 120 in a longitudinal direction Y, so that a tolerance in the longitudinal direction Y can be compensated for during a fastening operation of fastening the first component 120 to the second component. In the illustrated embodiment, the longitudinal direction Y is the axial direction of the compensation element 140.

In the illustrated embodiment (especially referring to FIGS. 1D, 1F and 2A), the main body 141 of the compensation element 140 is provided with helical grooves 143 on an outer surface thereof, and protrusions 122 are provided in a connecting hole 121 of the first component 120. The helical grooves 143 are configured to cooperate with the protrusions 122 to connect the compensation element 140 to the first component 120 and enable the compensation element 140 to move relative to the first component 120 in the longitudinal direction Y.

The main body 141 is provided with a plurality of helical grooves 143 on the outer surface thereof, and the plurality of helical grooves 143 are uniformly arranged around an axis of the main body 141, and correspondingly, a plurality of protrusions 122 uniformly distributed in a circumferential direction are provided in the connecting hole 121. Each protrusion 122 is shaped into a helical shape that matches the shape of the helical groove 143. Although in the illustrated embodiment, the helical grooves 143 are provided on the compensation element 140 and the protrusions 122 are provided on the first component 120, in some other embodiments, the positions of the helical grooves 143 and the protrusions 122 can be interchanged, that is, the helical grooves are provided in the connecting hole 121 of the first component 120, and the protrusions are provided on an outer surface of the compensation element 140.

As shown in FIGS. 1C, 1D, 1F and 2A-2C, the compensation element 140 comprises first stop structures and second stop structures respectively arranged at the first end 1411 and the second end 1412. The first stop structures and the second stop structures are configured to allow the compensation element 140 to be inserted into the connecting hole 121 of the first component 120, and to block the compensation element 140 from falling off from the connecting hole 121 of the first component 120.

In the illustrated embodiment, the first stop structure is a stop block 144 provided at an end of the helical groove 143. The stop block 144 is provided in the helical groove 143, that is, in a travel path of the protrusion 122 of the first component 120 in the helical groove 143, and thus can block the protrusion 122 of the first component 120 from moving out of the helical groove 143. The second stop structure comprises a biasable stop arm 145. An end of the stop arm 145 is connected to the main body 141. For example, the stop arm 145 is formed by providing an opening 146 in the main body 141 (as shown in FIGS. 2B and 2C). The opening 146 runs through a cylindrical wall of the substantially cylindrical main body 141, that is, the opening extends from the outer surface of the main body 141 to the receiving hole 142. At a blocking position thereof, the stop arm 145 can be stopped on an outer side of a mouth of the connecting hole 121 of the first component 120, and thus can prevent the compensation element 140 from falling off from the connecting hole 121 of the first component 120.

When the stop arm 145 is subjected to a pressure on an outer side thereof (such as a pressure applied by a hole wall of the connecting hole 121 of the first component 120, or the protrusion 122, or an operator's hand, or a mounting tool), the stop arm can be biased inward around an end thereof connected to the main body 141, that is, biased toward an inside of the receiving hole 142 of the main body 141, thereby leaving the blocking position thereof, such that the second end 1412 of the compensation element 140 that is provided with the stop arm 145 can be inserted into the connecting hole 121 of the first component 120. When the pressure is removed or reduced to a certain extent, the stop arm 145 can rebound outward to return to the blocking position thereof. The stop arm 145 extends substantially in a circumferential direction of the main body 141, thus having a longer effective blocking length.

The stop arm 145 comprises a driving portion 210 and a stop portion 220. The stop portion 220 is configured to be stopped on the outer side of the mouth of the connecting hole 121 of the first component 120. The driving portion 210 is closer to the second end 1412 of the compensation element 140 than the stop portion 220. The driving portion 210 is configured to be capable of driving, under squeezing of the connecting hole 121 when the second end 1412 of the compensation element 140 is inserted into the connecting hole 121 of the first component 120, the stop arm 145 to bias inward, to facilitate operations.

The driving portion 210 comprises a front end 211, a rear end 212, and a connecting section 213 connecting the front end to the rear end. The front end 211 is closer to the second end 1412 of the compensation element 140 and further away from the stop portion 220 than the rear end 212. The front end 211 is sized such that the front end can be inserted into the connecting hole 121 when the stop arm 145 is not biased, while the rear end 212 is sized such that the rear end cannot be inserted into the connecting hole 121 when the stop arm 145 is not biased. At least a part of an outer surface of the connecting section 213 extends obliquely relative to an axis of the compensation element 140. For example, the outer surface of the connecting section 213 may comprise one or more inclined flat surfaces or curved surfaces.

In the illustrated embodiment, the driving portion 210 is provided in the helical groove 143. When the second end 1412 of the compensation element 140 is being inserted into the connecting hole 121 of the first component 120, the front end 211 of the driving portion 210 enters the connecting hole 121 first. As the compensation element 140 continues to move into the connecting hole 121, the protrusion 122 in the connecting hole 121 squeezes the inclined outer surface of the connecting section 213, thereby providing a pressure to bias the stop arm 145 inward. In some other embodiments, the driving portion 210 may be provided outside the helical groove 143. When the second end 1412 of the compensation element 140 is inserted into the connecting hole 121 of the first component 120, the hole wall of the connecting hole 121 squeezes the connecting section 213 to provide a pressure to bias the stop arm 145 inward.

Although in the illustrated embodiment, the first stop structure is the stop block provided in the helical groove, and the second stop structure comprises the biasable stop arm, in some other embodiments, the formation methods of the first stop structure and the second stop structure can be interchanged, and an operation direction during pre-assembling of the fastening assembly 110 to the first component 120 is adjusted accordingly. The number of first stop structures and the number of second stop structures each may be set to one or more. When there is more than one helical groove 143, one first stop structure may be provided at an end of each helical groove 143, or first stop structures may be provided only at ends of some helical grooves 143. When there is more than one second stop structure, the stop structures are uniformly arranged around the axis of the main body 141.

As shown in FIGS. 1D and 2B, the main body 141 of the compensation element 140 comprises a cylindrical portion 1413 and a limiting flange 1414 provided at an end thereof, and the limiting flange 1414 is provided on the first compensation section 147. The limiting flange 1414 protrudes radially inward from the cylindrical portion 1410, such that the receiving hole 142 becomes smaller at the limiting flange 1414.

In general, the receiving hole 142 is sized such that the fastening element 130 and the holding element 150 can be inserted, and an enough gap is reserved between the receiving hole and the fastening element 130, so that the fastening element 130 can move in the receiving hole 142 in one or more transverse directions (including but not limited to an X-direction and a Z-direction) perpendicular to the longitudinal direction Y during the operation of fastening the first component 120 to the second component, so as to compensate for one or more tolerances in the one or more transverse directions.

The receiving hole 142 comprises a plurality of holes connected to each other in the axial direction, and the plurality of holes may be all circular holes, or one or more of the plurality of holes may be holes in other shapes. For example, due to the existence of the limiting flange 1414, the plurality of holes comprise a first hole 1421 provided at the first end 1411 of the compensation element 140 and a second hole 1422 adjacent to the first hole 1421. The first hole 1421 is defined by the limiting flange 1414, and has a diameter slightly greater than a thread major diameter of the threaded portion 1321 of the fastening element 130, but less than a maximum dimension of the limiting portion 133 in the transverse directions, that is, the first hole 1421 is sized to allow the threaded portion 1321 to pass through and allow the threaded portion 1321 to move in the first hole 1421 in one or more transverse directions to compensate for one or more tolerances in the one or more transverse directions, but not to allow the limiting portion 133 to pass through. The dimension of the second hole 1422 is slightly greater than the maximum dimension of the limiting portion 133 in the transverse directions, so that the limiting portion 133 can be received in the second hole 1422, and the limiting portion 133 is allowed to move in the second hole 1422 in one or more transverse directions to compensate for one or more tolerances in the one or more transverse directions.

The limiting flange 1414 is configured to stop the limiting portion 133 of the fastening element 130 to prevent the fastening element 130 from falling out of the receiving hole 142 from the first end 1411. During the operation of fastening the first component 120 to the second component, the fastening element 130 abuts against the limiting flange 1414 via the limiting portion 133, so as to drive the compensation element 140 and the first component 120 connected to the compensation element 140 to move toward the second component.

As shown in FIGS. 1D and 1E, the holding element 150 of the fastening assembly 110 is substantially an annular gasket with a circular cross-section. The holding element 150 is inserted into the receiving hole 142 and is arranged at least partially around the head 131 of the fastening element 130. The holding element 150 has elasticity. For example, the holding element 150 is made of a flexible plastic, which is, for example, polypropylene (PP), polyethylene (PE), soft polyvinyl chloride (PVC), a synthetic rubber material (such as ethylene propylene diene monomer (EPDM) and a thermoplastic elastomer (TPE/TPR)), or other suitable materials.

The holding element 150 is configured to be capable of resisting, when the fastening assembly 110 has not fasten the first component 120 to the second component (for example, during transportation and storage of the pre-assembled unit formed by the fastening assembly 110 and the first component 120, and during movement and alignment before the fastening assembly 110 and the first component 120 are fastened to the second component), a force that acts on the fastening element 130 to make the fastening element shake, the gravity, etc., such that the fastening element 130 is held substantially centrally in the receiving hole 142. This reduces or inhibits the shaking of the fastening element 130, and causes the fastening element 130 to be at or near a theoretical position, so as to facilitate quick connection of the driving tool to the driving feature 1311 of the fastening element 130 and quick fastening of the fastening assembly 110 to the second component during subsequent fastening. When the fastening assembly 110 fastens the first component 120 to the second component, the holding element 150 allows the fastening element 130 to move relative to the compensation element 140 in one or more transverse directions to compensate for one or more tolerances in the one or more transverse directions.

At a theoretical position, that is, when the fastening element 130 is exactly centrally located in the receiving hole 142, there may be a small gap between an inner side 151 of the holding element 150 and the head 131 of the fastening element 130, and/or between an outer side 152 of the holding element 150 and the receiving hole 142, so as to facilitate the assembly of the holding element 150 and ensure sufficient adjustment space in the one or more transverse directions.

Although in the embodiment shown in FIGS. 1A-2C, the holding element 150 is an integral part, in some other embodiments, the holding element 150 may be composed of one or more sub-elements. For example, the holding element 150 comprises two half rings or three or more sector rings.

In addition, although in the embodiment shown in FIGS. 1A-2C, the cross-section of the holding element 150 perpendicular to the longitudinal direction Y is circular, to facilitate manufacturing and assembly, and make the fastening element 130 stressed more uniformly in a circumferential direction, in some other embodiments, the holding element 150 may be provided in other shapes, for example, the inner side 151 and/or the outer side 152 of the holding element 150 is polygonal, elliptical, drum-shaped, runway-shaped, or the like, and the holding element 150 may not necessarily be configured as an integral ring, for example, the cross-section of the holding element 150 may be configured as a shape with an opening, such as a C shape or a U shape.

As shown in FIGS. 1D, 1E and 2B, the limiting element 160 of the fastening assembly 110 is integrally formed with the second compensation section 148 of the compensation element 140, which is a cylinder extending out from the second compensation section 148, and extends into the first compensation section 147. The holding element 150 is provided between the limiting portion 133 of the fastening element 130 and the limiting element 160 in the longitudinal direction Y. The limiting element 160 is configured to limit the holding element 150 in the receiving hole 142 in the longitudinal direction Y, to prevent the holding element 150 from falling out of the receiving hole 142 from the second end 1412.

In this way, the limiting portion 133 of the fastening element 130 is limited between the holding element 150 and the limiting flange 1414 of the compensation element 140 in the longitudinal direction Y, so as to be held in the receiving hole 142. In a pre-assembled state, a small gap may be reserved between the limiting portion 133 and the limiting flange 1414 of the compensation element 140, and/or between the holding element 150 and the limiting portion 133, and/or between the holding element 150 and the limiting element 160, so as to compensate for deviations caused by tolerances, material shrinkage, etc.

In other embodiments, the limiting element 160 may not be a component integrally formed with the compensation element 140, but a component separated from the compensation element 140 and provided in the receiving hole 142 of the compensation element 140. For example, the limiting element 160 is a retaining ring, which is detachably connected to the compensation element 140 by means of snap-fit, threaded connection or other means. In these embodiments, the main body 141 of the compensation element 140 may not be configured as a split structure, but as an integral structure.

As shown in FIGS. 1D and 1E, the fastening assembly 110 is assembled by means of the following method. First, the fastening element 130 is inserted into the first compensation section 147 of the compensation element 140, such that the stem 132 thereof is located in the first hole 1421 of the receiving hole 142, the head 131 thereof is located in the second hole 1422 of the receiving hole 142, and the limiting portion 133 thereof is adjacent to the limiting flange 1414 of the compensation element 140. Then, the holding element 150 is sleeved on the head 131 of the fastening element 130, and is adjacent to the limiting portion 133 of the fastening element 130. Subsequently, the second compensation section 148 of the compensation element 140 is connected to the first compensation section 147, such that the limiting element 160 is inserted into the first compensation section 147 and is adjacent to the holding element 150, and thus the assembled fastening assembly 110 can be obtained.

An operation method of pre-assembling the assembled fastening assembly 110 in the embodiment shown in FIGS. 1A-2C to the first component 120 is described below with reference to FIG. 1F. According to an orientation shown in FIG. 1F, before pre-assembly, the fastening assembly 110 is located on a left side of the first component 120, and the second end 1412 of the compensation element 140 faces the first component 120. During the pre-assembly operation:
1. The fastening assembly 110 is moved toward a right side until the second end 1412 of the compensation element 140 reaches the connecting hole 121 of the first component 120, then the helical grooves 143 of the compensation element 140 are aligned with the protrusions 122 of the first component 120, and the protrusions 122 are inserted into the helical grooves 143. The stop arms 145 are biased inward and leaves the blocking position thereof due to a pressure of the connecting hole 121, thereby not affecting the insertion of the second end 1412 into the connecting hole 121 and the movement of the fastening assembly 110 in the connecting hole 121.
2. Under the guidance of the protrusions 122 and the helical grooves 143, the compensation element 140 travels toward the right side while rotating. As the compensation element travels toward the right side to an extent that the stop arms 145 are exposed out of the connecting hole 121 from the right side of the connecting hole 121, the stop arms 145 rebound outward to return to the blocking position thereof.

Therefore, after the compensation element 140 is pre-assembled to the first component 120, when the compensation element 140 moves relative to the first component 120 toward the right side of the orientation shown in FIG. 1F to a first limit position, the stop blocks 144 provided at the first end 1411 of the compensation element 140 can abut against the protrusions 122 of the first component 120, so as to prevent the compensation element 140 from falling off from the connecting hole 121 of the first component 120. When the compensation element 140 moves relative to the first component 120 toward a left side of the orientation shown in FIG. 1F to a second limit position, the stop arms 145 provided at the second end 1412 of the compensation element 140 can abut against the outer side of the mouth of the connecting hole 121 of the first component 120, so as to prevent the compensation element 140 from falling off from the connecting hole 121 of the first component 120.

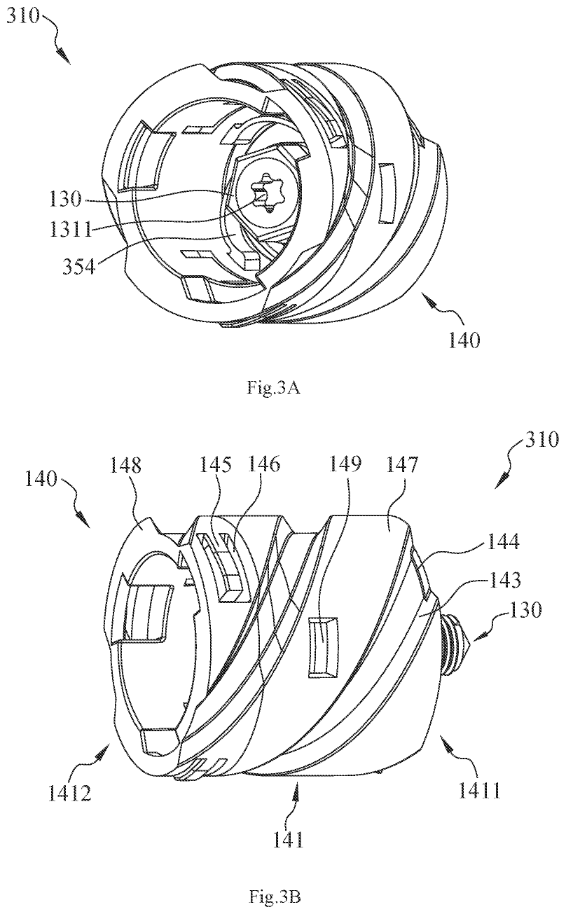

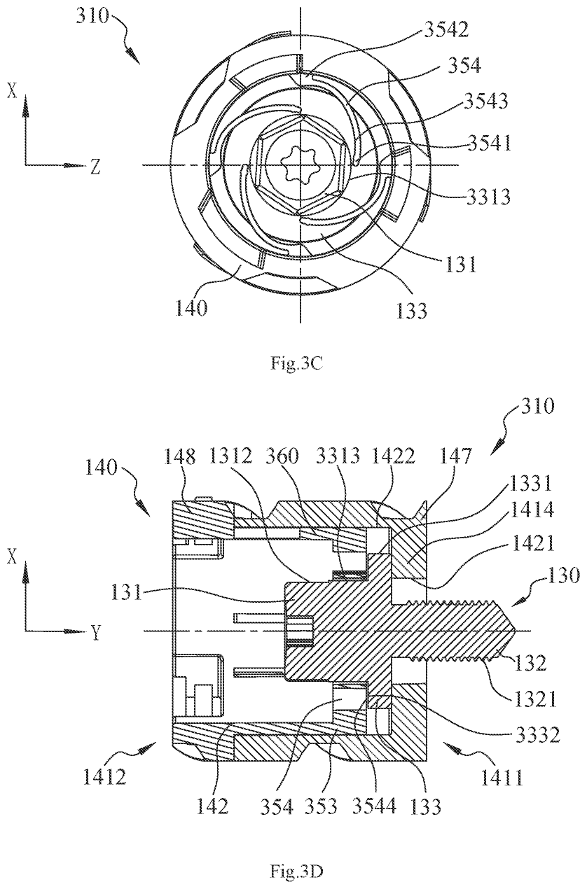

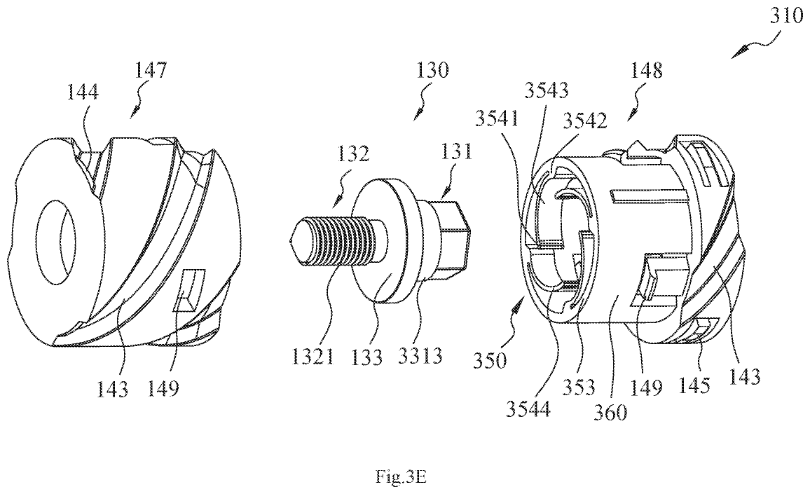

FIGS. 3A-3E illustrate a specific structure of a fastening assembly 310 according to another embodiment of the present disclosure. FIGS. 3A and 3B are perspective views of the fastening assembly 310 from different perspectives, FIG. 3C is a left view of the fastening assembly 310, FIG. 3D is a cross-sectional view of the fastening system 310 taken in an axial direction, and FIG. 3E is an exploded view of the fastening assembly 310. In this embodiment, some of the reference signs of the elements and some contents of the embodiment described above with reference to FIGS. 1A-2C are adopted, wherein the same reference signs are used to represent the same or similar elements, and the description of the same technical contents is selectively omitted. For the description of the omitted part, reference may be made to the aforementioned embodiment, and details are not described in this embodiment.

The fastening assembly 310 shown in FIGS. 3A-3E is provided with the fastening element 130 and the compensation element 140 described above with reference to FIGS. 1A-2C, and a holding element 350 and a limiting element 360 that are described in detail below. The fastening assembly 310 can be pre-assembled with the first component 120 described above with reference to FIGS. 1A-1F, to form a fastening system comprising the fastening assembly 310 and the first component 120. The fastening assembly 310 is configured to fasten the first component 120 to a second component and compensate for tolerances in various directions caused by manufacturing and/or assembly. The holding element 350 and the limiting element 360 in the embodiment of FIGS. 3A-3E respectively have substantially the same functions as the holding element 150 and the limiting element 160 in the embodiment of FIGS. 1A-2C, but have different structures.

As shown in FIGS. 3A-3E, the holding element 350 comprises a substantially annular outer peripheral portion 353 and a plurality of elastic arms 354 connected to a radial inner side of the outer peripheral portion 353. The elastic arms 354 each comprise an arm inner end 3541 close to the head 131 of the fastening element 130, and an arm outer end 3542 away from the head 131 and connected to the outer peripheral portion 353. The plurality of elastic arms 354 are arranged at intervals and symmetrically around an axis of the outer peripheral portion 353, that is, uniformly arranged in a circumferential direction. The holding element 350 is inserted into the receiving hole 142 and is arranged at least partially around the head 131 of the fastening element 130.

The elastic arm 354 is, for example, an elastic plastic sheet, with a width direction being substantially in an axial direction of the holding element 350, that is, in the longitudinal direction Y, and with a thickness direction being substantially in a direction perpendicular to the axial direction of the holding element 350, that is, in the transverse direction. When the fastening element 130 is located centrally in the receiving hole 142, there is a small gap between the arm inner end 3541 of the elastic arm 354 and the head 131 of the fastening element 130, such as a gap not greater than 0.2 mm in a radial direction, to facilitate assembly.

Through designing of the material, the thickness dimension, etc. of the elastic arm 354, the elastic arm 354 can have enough elasticity in the transverse direction, so that when the fastening assembly 310 has not fasten the first component 120 to the second component and the fastening element 130 deviates in the transverse direction due to shaking or gravity and presses one or more clastic arms 354, the one or more elastic arms 354 can align the fastening element 130 back by means of the elasticity thereof, such that the fastening element 130 is held substantially centrally in the receiving hole 142. This reduces or inhibits the shaking of the fastening element 130, and causes the fastening element 130 to be at or near a theoretical position, so as to facilitate quick connection of the driving tool to the driving feature 1311 of the fastening element 130 and quick fastening of the fastening assembly 310 to the second component during subsequent fastening. When the fastening assembly 310 fastens the first component 120 to the second component, the clastic arms 354 can allow the fastening element 130 to move relative to the compensation element 140 in one or more transverse directions to compensate for one or more tolerances in the one or more transverse directions.

The outer peripheral surface 1312 of the head 131 comprises a cylindrical surface 3313, and the cylindrical surface 3313 takes the axis of the fastening element 130 as an axis thereof and is opposite an inner side surface 3543 of each of the elastic arms 354. As viewed from the cross-section perpendicular to the longitudinal direction Y, the elastic arm 354 extends in a bent manner such that at least at the arm inner end 3541 and near the arm inner end 3541, an included angle between the inner side surface 3543 of the elastic arm 354 and the cylindrical surface 3313 of the head 131 is less than 90°, for example not greater than 45°, and thus a force applied by the elastic arm 354 to the head 131 via the arm inner end 3541 is relatively gentle and changes relatively gently.

Although in the illustrated embodiment, the elastic arm 354 extends in a bent manner from the arm outer end 3542 to the arm inner end 3541, in some other embodiments, the elastic arm 354 may only partially extend in a bent manner, or the elastic arm 354 may extend along a straight line with an included angle less than 90° with the outer peripheral surface 1312 of the head 131, or the clastic arm 354 may partially extend along a straight line and partially extend in a bent manner.

In addition, at a theoretical position, where the fastening element 130 is located exactly centrally in the receiving hole 142, there is a small gap between the arm inner end 3541 of each of the elastic arms 354 and the head 131 of the fastening element 130, such as a gap not greater than 0.2 mm in the radial direction, to facilitate assembly. In some other implementations, when the fastening element 130 is located exactly centrally in the receiving hole 142, the arm inner end 3541 of each of the elastic arms 354 may abut against the head 131 of the fastening element 130 without any gap therebetween, provided that the holding element 350 can hold the fastening element 130 at a substantially central position.

With continued reference to FIGS. 3A-3E, the limiting element 360 is integrally formed with the second compensation section 148 of the compensation element 140, which is a cylinder extending out from the second compensation section 148, and extends into the first compensation section 147. Moreover, the limiting element 360 is also integrally formed with the holding element 350. That is to say, the holding element 350, the limiting element 360, and the second compensation section 148 of the compensation element 140 are formed as one piece. The holding element 350 is integrally connected to the limiting element 360 via the outer peripheral portion 353 thereof, thereby not affecting the effect of the elastic arms 354 while limiting the holding element 350.

In this way, the limiting portion 133 of the fastening element 130 is limited between the holding element 350 and the limiting flange 1414 of the compensation element 140 in the longitudinal direction Y, so as to be held in the receiving hole 142. In a pre-assembled state, a small gap, such as a gap not greater than 0.2 mm, may be reserved between the limiting portion 133 and the limiting flange 1414 of the compensation element 140 and/or between the holding element 350 and the limiting portion 133, so as to compensate for deviations caused by tolerances, material shrinkage, etc.

Although in the illustrated embodiment, the limiting element 360 is integrally connected to the holding element 350, in some other implementations, the limiting element 360 and the holding element 350 may be provided as two separate parts, and an end of the limiting element 360 stops the outer peripheral portion 353 of the holding element 350 in the longitudinal direction Y, so as to hold the holding element 350 in the receiving hole 142. Moreover, in other embodiments, the limiting element 360 may alternatively not be integrally formed with the second compensation section 148 of the compensation element 140, but may be detachably connected to the compensation element 140.

With continued reference to FIGS. 3A-3E, each elastic arm 354 comprises a proximal end surface 3544 opposite the limiting portion 133 of the fastening element 130, and the proximal end surfaces 3544 of the plurality of elastic arms 354 are coplanar and are perpendicular to the longitudinal direction Y. The limiting portion 133 comprises a limiting portion end surface 3332 opposite the proximal end surface 3544, and the limiting portion end surface 3332 is perpendicular to the longitudinal direction Y, and is thus parallel to the proximal end surface 3544. Through designing of the material, the width dimension, etc. of the elastic arm 354, the elastic arm 354 can have a very low or substantially no elasticity in the longitudinal direction Y, so that the axis of the fastening element 130 can be kept substantially in the longitudinal direction Y, so as to ensure coaxiality between the axis of the fastening element 130 and a corresponding mounting hole in the second component.

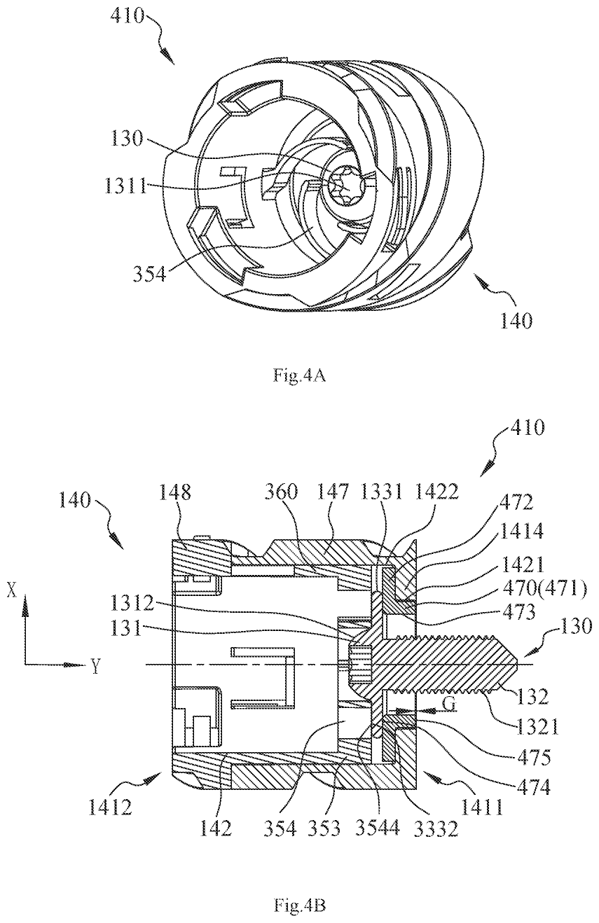

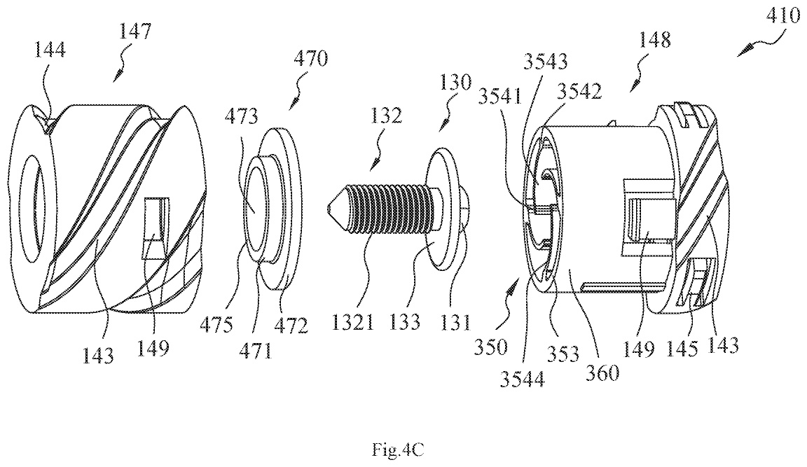

FIGS. 4A-4C illustrate a specific structure of a fastening assembly 410 according to a further embodiment of the present disclosure. FIG. 4A is a perspective view of the fastening assembly 410, FIG. 4B is a cross-sectional view of the fastening assembly 410 taken along an axial direction, and FIG. 4C is an exploded view of the fastening assembly 410. In this embodiment, some of the reference signs of the elements and some contents of the embodiments described above with reference to FIGS. 1A-3E are adopted, wherein the same reference signs are used to represent the same or similar elements, and the description of the same technical contents is selectively omitted. For the description of the omitted part, reference may be made to the aforementioned embodiments, and details are not described in this embodiment.

The fastening assembly 410 shown in FIGS. 4A-4C differs from the fastening assembly 310 shown in FIGS. 3A-3E mainly in that the fastening assembly 410 shown in FIGS. 4A-4C further comprises an isolation member 470 provided between the fastening element 130 and the compensation element 140, and the head 131 of the fastening element 130 of the fastening assembly 410 shown in FIGS. 4A-4C has a simpler structure so that the cost can be reduced.

The isolation member 470 is made of a material having a higher strength than the compensation element 140. For example, the compensation element 140 is made of plastic, and the isolation member 470 is made of metal. The isolation member 470 comprises a sleeve portion 471 and a flange portion 472.

The sleeve portion 471 comprises a proximal end 474 and a distal end 475 which are axially opposite to each other, with the distal end 475 inserted into the first hole 1421 of the compensation element 140. A radial inner side of the sleeve portion 471 defines a channel 473, and the threaded portion 1321 of the fastening element 130 is inserted into the channel 473. The channel 473 is configured to allow the threaded portion 1321 of the fastening element 130 to pass through and allow the threaded portion 1321 to move in the channel 473 in one or more transverse directions to compensate for one or more tolerances in the one or more transverse directions, but not to allow the limiting portion 133 to pass through. The distal end 475 of the sleeve portion 471 extends no further than the first hole 1421, i.e., extends no further than an end surface of the first end 1411 of the compensation element 140.

The flange portion 472 is provided at the proximal end 474 of the sleeve portion 471 and extends outward from a radial outer side surface of the sleeve portion 471 to form a substantially annular structure. The flange portion 472 can be stopped by the limiting flange 1414 of the compensation element 140, and thus limited between the limiting portion 133 of the fastening element 130 and the compensation element 140 in the longitudinal direction Y.

Therefore, when the fastening assembly 410 fastens the first component 120 to the second component, an axial fastening force of the fastening element 130 can be directly withstood by the isolation member 470 of higher strength, so as to protect the compensation element 140 of lower strength, reduce the risk of plastic deformation, cracking, or other failures of the compensation element 140, and prolong the service life of the compensation element 140.

The flange portion 472 has a transverse dimension greater than that of the limiting portion 133. Therefore, when the axial fastening force of the fastening element 130 is applied to the compensation element 140 via the flange portion 472, due to a larger stressed area, the pressure acting on the compensation element 140 is smaller, and after transmission by means of the flange portion 472, the pressure acting on the compensation element 140 is distributed more uniformly, so that the risk of failures of the compensation element 140 can be reduced, and the service life of the compensation element 140 can be prolonged.

An end surface of the distal end 475 of the sleeve portion 471 is retracted toward an inside of the first hole 1421 relative to the end surface of the first end 1411 of the compensation element 140, with a gap G between the two end surfaces. In this way, when the fastening assembly 410 fastens the first component 120 to the second component, the axial fastening force of the fastening element 130 acts on the compensation element 140 made of a plastic material via the isolation member 470, so that a hole wall of the first hole 1421 is compressed and an axial length of the first hole 1421 is shortened, thereby eliminating the aforementioned gap G and causing the distal end 475 of the sleeve portion 471 to abut against the second component. Therefore, the axial fastening force of the fastening element 130 and the pressure applied by the second component are borne mainly by the isolation member 470, so as to protect the compensation element 140, reduce the risk of failures of the compensation element 140, and prolong the service life of the compensation element 140.

Although the present disclosure is described with reference to the examples of embodiments outlined above, various alternatives, modifications, variations, improvements and/or substantial equivalents, which are known or anticipated at present or to be anticipated before long, may be obvious to those of at least ordinary skill in the art. Furthermore, the technical effects and/or technical problems described in this description are exemplary rather than limiting. Therefore, the disclosure in this description may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier developed alternatives, modifications, variations, improvements and/or substantial equivalents.

What is claimed is:

1. A fastening assembly for fastening a first component (120) to a second component, the fastening assembly comprising:
a fastening element (130) comprising a head (131), a threaded portion (1321), and a limiting portion (133), wherein the limiting portion (133) is provided at the head (131) or between the head (131) and the threaded portion (1321), and the limiting portion (133) protrudes outward relative to an outer peripheral surface (1312) of the head (131);
a compensation element (140) comprising a main body (141) and a receiving hole (142), wherein the receiving hole (142) runs through the main body (141) in an axial direction of the compensation element (140) to receive the fastening element (130), the main body (141) is provided with a limiting flange (1414) at an end thereof to stop the fastening element (130), and the compensation element (140) is configured to be connectable to the first component (120) and movable relative to the first component (120) in a longitudinal direction (Y);
a holding element (150, 350) arranged at least partially around the head (131) of the fastening element (130), wherein at least a part of the holding element (150, 350) has elasticity, the holding element (150, 350) is configured to hold the fastening element (130) substantially centrally in the receiving hole (142) when the fastening assembly is not fastened to the second component, and to allow the fastening element (130) to move relative to the compensation element (140) in a transverse direction perpendicular to the longitudinal direction (Y) when the fastening assembly is fastened to the second component; and
a limiting element (160, 360) connected to the compensation element (140) and provided in the receiving hole (142), wherein the limiting element (160, 360) is configured to limit the holding element (150, 350) in the receiving hole (142) in the longitudinal direction (Y);
wherein the limiting portion (133) of the fastening element (130) is limited between the holding element (150, 350) and the limiting flange (1414) of the compensation element (140) in the longitudinal direction (Y), so as to be held in the receiving hole (142).

2. The fastening assembly according to claim 1, wherein
the main body (141) of the compensation element (140) comprises a first compensation section (147) and a second compensation section (148) which are arranged in the axial direction of the compensation element and are detachably connected to each other, wherein the limiting flange (1414) is provided on the first compensation section (147), and the second compensation section (148) provides the limiting element (160, 360).

3. The fastening assembly according to claim 2, wherein
the limiting element (160, 360) is a cylinder extending out from the second compensation section (148) and extending into the first compensation section (147).

4. The fastening assembly according to claim 2, wherein
the first compensation section (147) and the second compensation section (148) are respectively made of different materials, wherein the second compensation section (148) has a strength less than that of the first compensation section (147).

5. The fastening assembly according to claim 1, wherein
the holding element (350) comprises an outer peripheral portion (353) and a plurality of elastic arms (354) arranged at intervals around an axis of the holding element (350), wherein the elastic arms (354) each comprise an arm inner end (3541) close to the head (131) of the fastening element (130) and an arm outer end (3542) away from the head (131), and the arm outer end (3542) is connected to the outer peripheral portion (353).

6. The fastening assembly according to claim 5, wherein
each of the elastic arms (354) extends in a bent manner from the arm outer end (3542) to the arm inner end (3541).

7. The fastening assembly according to claim 5, wherein
each of the elastic arms (354) comprises an inner side surface (3543) opposite the outer peripheral surface (1312) of the head (131), and as viewed from a cross-sectional perspective, at least at the arm inner end (3541) and near the arm inner end (3541), an included angle between the inner side surface (3543) and the outer peripheral surface (1312) is less than 90°.

8. The fastening assembly according to claim 7, wherein
the outer peripheral surface (1312) of the head (131) comprises a cylindrical surface (3313) opposite the inner side surface (3543) of the elastic arms (354).

9. The fastening assembly according to claim 5, wherein
when the fastening element (130) is located exactly centrally in the receiving hole (142), there is a radial gap between the arm inner end (3541) of each of the elastic arms (354) and the head (131) of the fastening element (130).

10. The fastening assembly according to claim 5, wherein
each of the elastic arms (354) comprises a proximal end surface (3544) opposite the limiting portion (133) of the fastening element (130), and the limiting portion (133) comprises a limiting portion end surface (3332) opposite the proximal end surface (3544), wherein the proximal end surfaces (3544) of the plurality of elastic arms (354) are coplanar and are parallel to the limiting portion end surface (3332).

11. The fastening assembly according to claim 2, wherein
the limiting element (360) is a component integrally formed with the holding element (350) or a component separated from the holding element (350).

12. The fastening assembly according to claim 1, wherein
the holding element (150) is made of an elastic material, and the holding element (150) has an annular cross-section.

13. The fastening assembly according to claim 1, wherein
the main body (141) of the compensation element (140) is provided with a helical groove (143) on an outer surface thereof, and the spiral groove (143) is configured to connect the compensation element (140) to the first component (120); and
wherein the compensation element (140) comprises a first stop structure and a second stop structure respectively arranged at two ends thereof in the axial direction, and the first stop structure and the second stop structure are configured to allow the compensation element (140) to be inserted into a hole of the first component (120), and to block the compensation element (140) from falling off from the hole of the first component (120), so as to pre-assemble the fastening assembly on the first component (120), wherein one of the first stop structure and the second stop structure comprises a stop block (144) provided at an end of the helical groove (143), and the other of the first stop structure and the second stop structure comprises a biasable stop arm (145) extending substantially in a circumferential direction of the main body (141).

14. A fastening system (100), comprising:
a fastening assembly according to claim 1; and
a first component (120).
